(19) United States
(12) Patent Application Publication
(10) Pub. No.: US 2008/0248828 A1
(43) Pub. Date: Oct. 9, 2008

(54) Mobile Terminal Apparatus, Printing System, Printing Communication Control Method, and Computer Program of the Same

(76) Inventor: Kaoru Tomiyasu, Yokohama-shi (JP)

Correspondence Address: HOGAN & HARTSON L.L.P., 1999 AVENUE OF THE STARS, SUITE 1400, LOS ANGELES, CA, 90067, US

(21) Appl. No.: 11/575,471

(22) PCT Filed: Sep. 14, 2005
(86) PCT No.: PCT/JP05/16972

§ 371 Date: Nov. 20, 2007

(30) Foreign Application Priority Data
Sep. 17, 2004 (JP) 2004-272052
Sep. 17, 2004 (JP) 2004-272053
Sep. 17, 2004 (JP) 2004-272054

(51) Int. Cl. H04M 1/00

(52) U.S. Cl. 455/550.1

(57) ABSTRACT

A mobile terminal apparatus (10) which can selectively conduct one of a printing operation and an operation corresponding to an event when the event is generated. In this mobile terminal apparatus (10), when the generation of an event of an incoming call, or the like is detected while conducting the printing operation, a control portion (13) selects whether an event operation corresponding to the event or the printing operation has priority to be conducted based on information set beforehand in a memory (20).

### TECHNICAL FIELD

The present invention relates to a mobile terminal apparatus which is connected to a printer via a cable and outputs image data to the printer, a printing system, a printing communication control method and a computer program of the same.

Priority is claimed on Japanese Patent Applications No. 2004-272052, No. 2004-272053 and No. 2004-272054 filed Sep. 17, 2004, the contents of which are incorporated herein by reference.

### BACKGROUND ART

In a prior art, a digital camera and a digital video recorder/player are generally known which are connected to a printer via a cable and request the printer to print an image which is specified by a user (for example, see Japanese Patent Application, First Publication No. H11-155120 and Japanese Patent Application, First Publication No. 2001-218096). Moreover, in recent years, other than the digital camera and the digital video recorder/player, a camera has been increasingly installed or mounted on cellular phones, PDAs (Personal Digital Assistants), and the like. There is a tendency in which cameras mounted on these apparatuses are increasing their pixels and show its capabilities that is almost same as the digital camera and the like. Because of such a tendency, with respect to characteristic technologies of the digital camera, there are needs or desire of mounting or implementing them on mobile terminal apparatuses, and a function of directly connecting to a printer and printing the image as described above is one of such technologies. Here, with respect to printing data which is printed by such a printer, data size is gradually increasing along with an increase in the pixels of the digital camera; and therefore, there is a tendency in which it takes a long time for transmitting or sending the data to the printer. Moreover, in such a system which prints by using a directly connected printer, a constitution is applied in which an ID is assigned to the image data which is to be printed in order to control transmission and reception of the image data, and the image data is transmitted in accordance with the ID that is transmitted from the printer.

However, the interface provided by the conventional digital camera for connecting to the printer is constituted on the assumption that there is no interruption while the printing operation is conducted; therefore, there is a problem in which it cannot be applied to a mobile terminal apparatus such as the cellular phone because there are unexpected events such as reception of a phone call, the arrival of an email, or the like.

Furthermore, in a case of printing by using the printer which is directly connected to the mobile terminal apparatus, other than transmission and reception operations of the image data, for example, there are occasions such as the reception of a phone call via wireless communication, the event of sounding various warnings or sounding an alarm as in an alarm clock, or the like; therefore, there is a problem in which multiple events should be dealt.

### DISCLOSURE OF INVENTION

The present invention was conceived in order to solve the above-described problem, and the present invention has an object to provide a mobile terminal apparatus, a printing system and a printing communication control method of the same which can conduct an appropriate operation even if an unexpected event is occurred such as the reception of a phone call, the arrival of an email, or the like.

In accordance with the present invention, it is possible to obtain a mobile terminal apparatus, a printing system, a printing communication control method and a computer program of the same which can select and conduct one of a printing operation and an operation corresponding to an event even if an unexpected event occurs such as the reception of a phone call, the arrival of an email, or the like.

In accordance with the present invention, it is possible to obtain a mobile terminal apparatus, a printing system, a printing communication control method and a computer program of the same which can conduct an operation corresponding to an event so as not to affect a printing operation even if an unexpected event including the reception of a phone call a notifying event such as an alarm, or the like occurs.

Moreover, in accordance with the present invention, it is possible to obtain a mobile terminal apparatus, a printing system, a printing communication control method and a computer program of the same which can, even if an unexpected event including the reception of a phone call, a notifying event such as an alarm, or the like occurs, conduct a printing operation after conducting an operation corresponding to the event.

In order to solve the above-described problems, the present invention provide a mobile terminal apparatus includes: a memory unit which stores image data; a printing communication unit which communicates with a connected apparatus for printing the image data and which reads and transmits the image data from the memory unit; and a control unit which selects whether an event operation which corresponds to the event or a printing operation has priority when a generation of the event is detected while conducting the printing operation by the printing communication unit.

The present invention is the above-described invention in which the memory unit storing priority information indicates whether the event operation or the printing operation has priority; and the control unit conducts a priority operation based on the priority information stored in the memory unit.

The present invention is the above-described invention in which if a generation of an event is detected in a case in which the printing operation is set to be an operation with priority, the control unit notifies the generation of the event after the printing communication unit finishes transmitting the image data.

The present invention is the above-described invention in which if a generation of an event is detected in a case in which the event operation is set to be an operation with priority, the transmission of the image data by the printing communication unit is suspended.

The present invention is the above-described invention in which the generated event has a plurality of types; and the memory unit stores the priority information in correspondence with the types of the event.

The present invention is the above-described invention in which the mobile terminal apparatus comprises a wireless communication unit which can connect to a public communication network, the event is an incoming call via the wireless communication unit; and if a generation of the incoming call is detected in a case in which the printing operation is set to be an operation with priority while the printing operation is conducted, at least one of following control functions is conducted: (a) forwarding the incoming call to a predetermined forwarding address; (b) responding to the incoming call along with recording a received voice message; (c) holding the incoming call; and (d) responding to the incoming call along with transmitting a predetermined message.

The present invention is the above-described invention in which when the control unit receives a command whether the event operation or the printing operation is conducted as an operation with priority via the operation unit, priority information with respect to the operation with priority is stored by the control unit to the memory unit.

The present invention is a printing system which includes: a mobile terminal apparatus of the above-described invention; and an image forming apparatus which prints image data received from the mobile terminal apparatus, wherein the image forming apparatus includes: a second control unit which communicates with the communication unit for printing, an image receiving unit which receives the image data from the mobile terminal apparatus, and an image outputting unit which outputs the image data received by the image receiving unit as an image.

The present invention is a printing communication method of a mobile terminal apparatus which connects to an image forming apparatus that prints image data, and which transmits image data that is stored beforehand to the image forming apparatus, including: conducting an operability/usability check and recognition with the mobile terminal apparatus when a connection to the image forming apparatus is detected; electing image data to be printed; conducting a printing operation of the selected image data; attempting to detect a generation of an event while conducting the printing operation; and selecting whether an event operation corresponding to the event or the printing operation is conducted as an operation with priority when the event is detected.

The present invention is a mobile terminal apparatus which includes: a storage unit which stores image data; a printing communication unit which communicates with a connected apparatus for printing the image data and which reads and transmits the image data from the memory unit; and a control unit which, if a generation of the event is detected while conducting the printing operation by the printing communication unit, conducts an event operation corresponding to the event when transmission of at least one set of image data is finished.

The present invention is the above-described invention, wherein if the control unit detects the generation of the event while transmitting the image data via the printing communication unit and conducts the event operation corresponding the event when transmission of at least one set of the image data which is transmitted is finished, the control unit suspends the printing operation.

The present invention is the above-described invention, wherein if the event operation which is conducted after suspending the printing operation is finished and there is other image data following the one set of image data, the control unit requests the printing communication unit to transmit the other image data.

The present invention is the above-described invention, wherein when the control unit suspends the printing operation of the printing communication unit, the control unit stores information of the progress of the printing operation to the memory unit in order to resume the printing operation.

The present invention is the above-described invention, wherein the event is a mail reception event, and the event operation is a connection operation to a mail server in order to receive electronic mail.

The present invention is a printing system which includes: a mobile terminal apparatus of the above-described invention; and an image forming apparatus which prints the image data received from the mobile terminal apparatus, wherein the image forming apparatus includes: a second control unit which communicates with the printing communication unit with respect to the printing operation; an image receiving unit which receives image data from the mobile terminal apparatus; and an image output unit which outputs the image data as an image which is received by the image receiving unit.

The present invention is a printing communication method of a mobile terminal apparatus which connects to an image forming apparatus that prints image data, and which transmits image data that is stored beforehand to the image forming apparatus, includes: selecting image data to be printed; conducting a printing operation of the selected image data; attempting to detect a generation of an event while conducting the printing operation; detecting the end of transmission of one set of the image data which is transmitted while conducting the printing operation; and conducting an event operation corresponding to the event when the end of transmission of the one set of the image data is detected.

The present invention is a mobile terminal apparatus which includes: a memory unit which stores image data; a printing communication unit which communicates with a connected apparatus for printing the image data and which reads and transmits the image data from the memory unit; and a control unit which, if a generation of the event is detected while conducting a printing operation by the printing communication unit, suspends transmitting the image data and conducts an event operation corresponding to the event.

The present invention is the above-described invention, wherein the printing communication unit assigns identification information which is identifiable to the image data respectively which is a target of the printing operation, and transmits the identification information to an image forming apparatus, and the control unit stores a relationship of correspondence between the identification information and the image data to the memory unit upon suspension of transmitting the image data, and transmits the image data to the image forming apparatus based on the relationship of correspondence after finishing the event operation.

The present invention is the above-described invention, wherein the control unit requests the printing communication unit to transmit the image data corresponding to the requested identification information from the image forming apparatus to the image forming apparatus based on the relationship of correspondence after finishing the event operation.

The present invention is the above-described invention, wherein the control unit stores information of the progress of transmission of the image data as resume information to the memory unit in order to resume transmitting the image data when the control unit suspends transmitting the image data via the printing communication unit, and resumes based on the resume information.

The present invention is the above-described invention, wherein the control unit, when a transmission of the image data is suspended because a generation of an event is detected while the printing communication unit is conducting a printing operation, does not suspend transmitting the image data until one set of the image data is completed, and suspends transmitting other image data following the one set of the image data.

The present invention is the above-described invention, wherein the control unit transmits a request for the printing communication unit to transmit the other image data following the one set of the image data when the event operation is finished.

The present invention is a printing system which comprises: a mobile terminal apparatus of the above-described invention; and an image forming apparatus which prints the image data received from the mobile terminal apparatus, wherein the image forming apparatus includes: a second control unit which communicates with the printing communication unit for a printing operation; an image receiving unit which receives image data from the mobile terminal apparatus; and an image output unit which outputs the image data as an image which is received by the image receiving unit.

The present invention is a printing communication method of a mobile terminal apparatus which connects to an image forming apparatus that prints image data, and transmits image data that is stored beforehand to the image forming apparatus, includes: selecting image data to be printed; conducting a printing operation of the selected image data; attempting to detect a generation of an event while conducting the printing operation; suspending transmission of the image data which is transmitted in the printing operation when a generation of the event is detected; and conducting an event operation corresponding to the event after suspension of transmitting the image data.

### BRIEF DESCRIPTION OF THE DRAWINGS

FIG. 1 is a block diagram showing a printing system of this embodiment.

FIG. 2 is a drawing showing a data constitution of image data of this embodiment.

FIG. 3 is a flowchart (No. 1) showing a printing operation of this embodiment.

FIG. 4 is a flowchart (No. 2) showing a printing operation of this embodiment.

FIG. 5 is a flowchart showing a priority setting via a function setting menu of this embodiment.

FIG. 6 is a screen transition diagram with respect to a case of setting a priority via a function setting menu of this embodiment.

FIG. 7 is a flowchart showing a priority setting via a printing operation menu of this embodiment.

FIG. 8 is a screen transition diagram with respect to a case of setting a priority via a printing operation menu of this embodiment.

FIG. 9 is a flowchart showing a determination operation of a priority setting of this embodiment.

FIG. 10 is a sequence diagram showing a priority operation in a case in which the printing operation has higher priority in this embodiment.

FIG. 11 is a screen transition diagram in a case in which the printing operation has higher priority in this embodiment.

FIG. 12 is a sequence diagram showing a priority operation in a case in which the reception of a phone call has higher priority and printing is stopped in this embodiment.

FIG. 13 is a sequence diagram showing a priority operation in a case in which the reception of a phone call has higher priority and printing is suspended in this embodiment.

FIG. 14 is a screen transition diagram in a case in which the reception of a phone call has higher priority in this embodiment.

### BEST MODE FOR CARRYING OUT THE INVENTION

Hereinbelow, a mobile terminal apparatus and a printing system of one embodiment of the present invention is explained with reference to the drawings. It should be noted that the scope of the present invention is not limited by the embodiments below, and for example, it is possible to appropriately combine or mix constitutional elements of the embodiments.

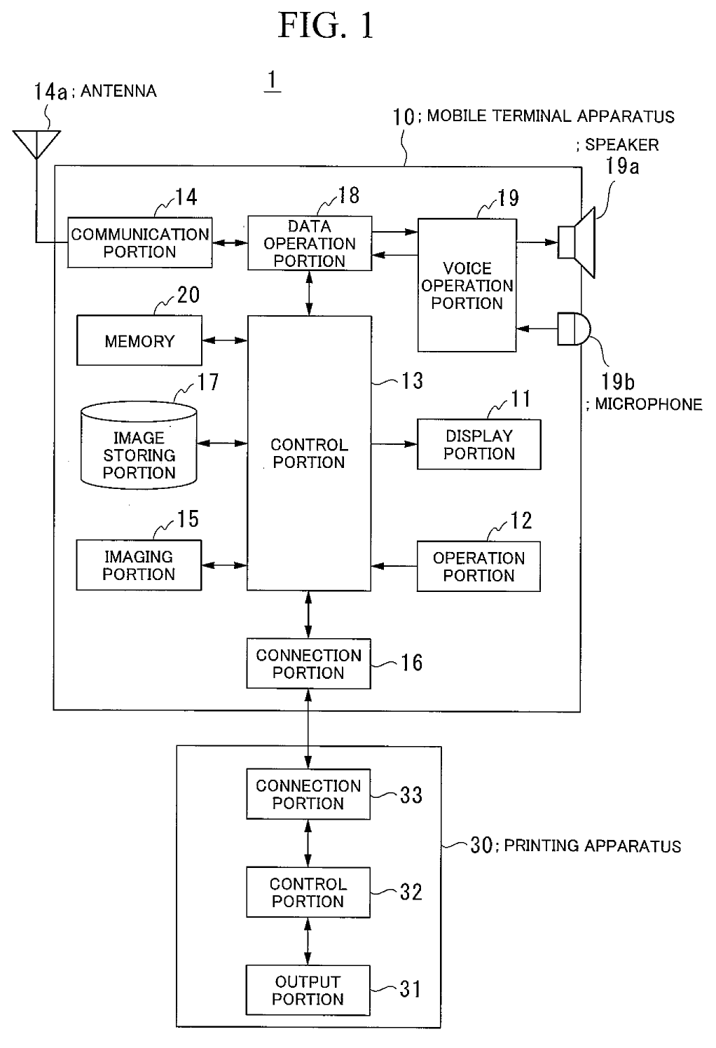

FIG. 1 is a schematic block diagram showing a printing system 1 of this embodiment which is constituted from a mobile terminal apparatus 10 and a printing apparatus 30. In this drawing, the printing apparatus 30 corresponds to the above-described image forming apparatus, and for example, the printing apparatus 30 is a printer which has a direct printing function that can print image data directly received from a digital camera or the like which is directly connected via an USB (Universal Serial Bus) cable without passing the data via a personal computer.

A connection portion 33 of the printing apparatus 30 is a connection interface such as above-described USB, and is directly connected to the mobile terminal apparatus 10 as described below. When the connection portion 33 detects that the printing apparatus 30 and the mobile terminal apparatus 10 are connected, a control portion 32 checks whether or not the mobile terminal apparatus 10 is appropriate for an image data transmission/reception method provided by the printing apparatus 30 and whether or not it is operable or usable, and the control portion 32 authenticates or accepts the mobile terminal apparatus 10 if it is an appropriate apparatus. Moreover, when the mobile terminal apparatus 10 is authenticated or accepted after an operability/usability check and recognition, the printing apparatus 30 transmits information of a format of the image data that is possible to be printed by the printing apparatus 30 to the mobile terminal apparatus 10. Furthermore, the mobile terminal apparatus 10 is requested the image data via the connection portion 33, and the image data is received. An output portion 31 prints the image data received by the control portion 32 on a sheet of paper and the like.

On the other hand, in the same drawing, the mobile terminal apparatus 10 is, for example, a cellular phone terminal which can obtain an image by using a built-in camera, and has a function to communicate via a phone line and conduct Internet communications after connecting to the base station of a cellular phone communication carrier.

In the mobile terminal apparatus 10, the connection portion 16 is, for example, an USB interface which is connected to the printing apparatus 30. An imaging portion 15 is, for example, a CCD (Charge Coupled Device) camera which is internally provided by the mobile terminal apparatus 10 and which takes an image in accordance with a user's operation. A communication portion 14 has an antenna 14a, connects to a base station of a cellular phone communication carrier, and conducts a telephone communication. Moreover, the communication portion 14 connects to the Internet via a communication station of the cellular phone communication carrier, and conducts transmission/reception of electrical mail.

An image storing portion 17 stores image data which is taken by the imaging portion 15.

A display portion 11 is, for example, a liquid crystal display and shows a menu for selecting a setting option when a priority setting is conducted in accordance with a user's operation as described below. An operation portion 12 is, for example, a keyboard and transmits a command corresponding to a selected setting option in accordance with a selection via the keyboard by a user from the setting options displayed on the display portion 11.

When the user operates the operation portion 12 and the control portion 13 conducts a setting operation, information and the like which is set is stored in a memory 20. Moreover, data is stored in the memory 20 such as email received by the control portion 13 via a data operation portion 18.

When the reception of a phone call is received via the communication portion 14 and a call or a telephone communication is established in accordance with commands of the control portion 13, the data operation portion 18 transmits a sound signal received by the communication portion 14 to a voice operation portion 19. Moreover, the data operation portion 18 receives a sound signal and transmits it to the communication portion 14. Furthermore, when email is received, the data operation portion 18 transmits the email to the control portion 13.

The voice operation portion 19 has a speaker 19a and a microphone 19b, converts sound signals received from the data operation portion 18 to a voice, and outputs it from the speaker 19a. Moreover, the voice operation portion 19 converts a voice from a user received by the microphone 19b to a sound signal and transmits it to the data operation portion 18.

The control portion 13 receives setting information input in accordance with a user's operation via the operation portion 12, and stores the setting information to the memory 20. Moreover, the control portion 13 stores image data taken by the imaging portion 15, image data attached to email, and the like to the image storing portion 17. Furthermore, email received via the data operation portion 18 is stored in the memory 20.

Here, the above-described image forming apparatus corresponds to the printing apparatus 30, and the mobile terminal apparatus corresponds to the mobile terminal apparatus 10. Moreover, the control unit and the first control unit correspond to the control portion 13, and the memory unit corresponds to the memory 20. Furthermore, the image receiving unit corresponds to the connection portion 33 of the printing apparatus 30, the second control unit corresponds to a control portion 32 of the printing apparatus 30, and the output unit corresponds to the output portion 31.

The mobile terminal apparatus 10 and the printing apparatus 30 are physically and directly connected by using, for example, a USEB cable; however, it should be noted that it is possible to apply a different constitution of connectivity by using, for example, a near field wireless communication such as Bluetooth (registered trademark), infrared such as IrDA, or the like.

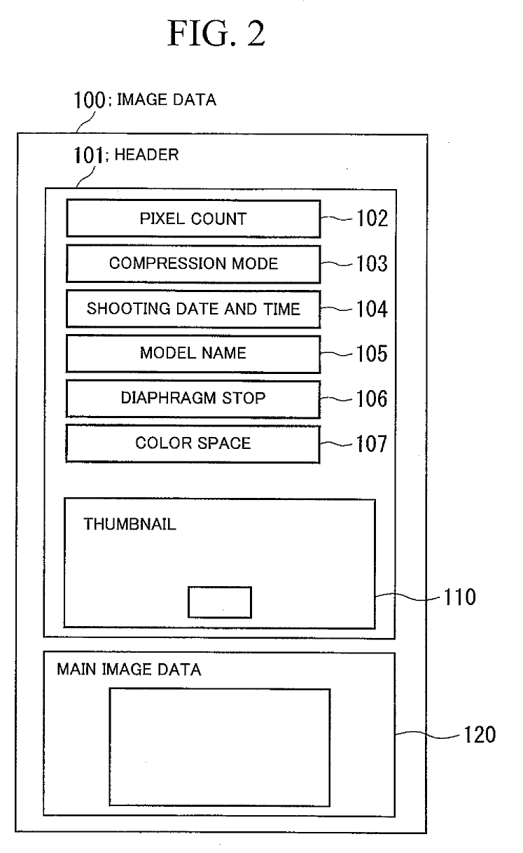

FIG. 2 is a drawing showing the data constitution of a format of image data 100 which is printed by the printing apparatus 30. As a format corresponding to this format, there is, for example, Exif (exchange image file format) (registered trademark) which is an extended JPEG image format (hereinafter, this format is called an extended JPEG format).

In this drawing, the image data 100 is constituted from a header 101 and the main image data 120. The header 101 contains a pixel count 102 which is information obtained when the main image data 120 is taken, shooting date and time 104, a model name 105 and an diaphragm stop 106, and moreover, there is information such as a compression mode 103 which is information for accurately reading the main image data 120, color space 107, and the like. This information is written by the mobile terminal apparatus 10 when the user takes an image with the mobile terminal apparatus 10. Moreover, if the image data 100 is generated by producer of paid content, such information is written by software and the like which generates the image.

A thumbnail 110 is image data which is obtained by reducing the main image data 120, and its size is predetermined; therefore, it is possible to display a list at high speed on a screen in a case of using software, or the like. In the main image data, the main body of the image data is included, and image data in JPEG (Joint Photographic Coding Experts Group) which can be printed by the printing apparatus 30 of this embodiment is stored. It should be noted that, with respect to the file name of the image data 100 in this format, the extension “JPG” which is same as a normal JPEG file such as “XXXXX.JPG” is applied; therefore, in order to confirm whether or not the image data 100 is the image data in this format or a generally used JPEG, it is necessary to confirm whether or not the header 101 exists.

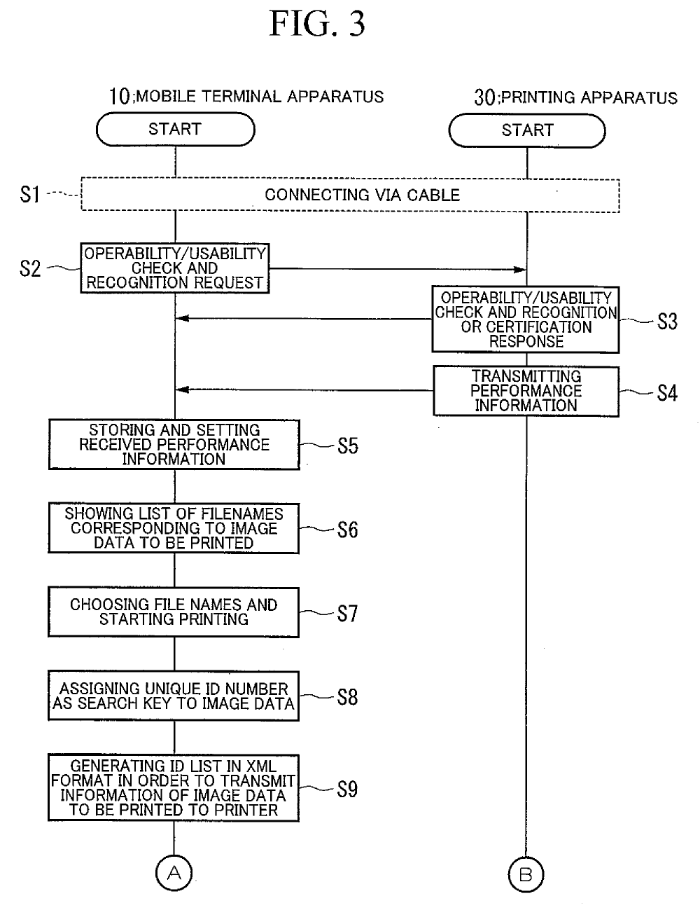

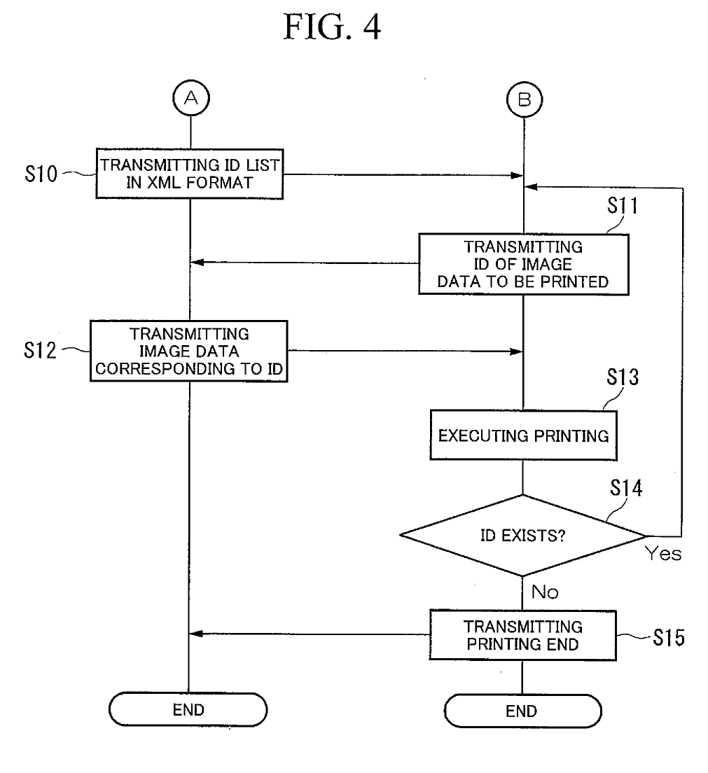

FIG. 3 and 4 are flowcharts which show a printing operation of the image data conducted between the mobile terminal apparatus 10 and the printing apparatus 30. In this drawing, an operation of step S1 which is surrounded by a dashed-line indicates that the operation is conducted by a user, and other operations which are surrounded by solid-lines are conducted by the mobile terminal apparatus 10 or the printing apparatus 30.

First, the mobile terminal apparatus 10 and the printing apparatus 30 are connected by the user via a cable (step S1). When the cable is connected, the connection portion 16 of the mobile terminal apparatus 10 and the connection portion 33 of the printing apparatus 30 detect a connection to each other. The control portion 13 of the mobile terminal apparatus 10, in order to get or undergo an operability/usability check and recognition, transmits an operability/usability check and recognition request which includes information of a device class set beforehand and the like to the mobile terminal apparatus 10 to the printing apparatus 30 via the connection portion 16 (step S2). After receiving the operability/usability checking and recognition request, the control portion 32 of the printing apparatus 30 checks whether or not the mobile terminal apparatus 10 is an apparatus which is appropriate for a transmission/reception method of the image data provided by the printing apparatus 30 based on the information included in the operability/usability check and recognition request. When the mobile terminal apparatus 10 is determined to be an apparatus which is appropriate, the mobile terminal apparatus 10 is recognized or certified and a recognition or certification response is transmitted (step S3).

When the recognition or certification success, the mobile terminal apparatus 10 transmits a request (not shown in the drawings) to the printing apparatus 30 to transmit performance information including information of such as the format of printable image data, for example, information of the extensions of files, the above-explained extended JPEG format, and the like. The printing apparatus 30 transmits the information to the mobile terminal apparatus 10 (step S4). The control portion 13 of the mobile terminal apparatus 10 stores the received performance information to the memory 20 (step S5).

After receiving a user's command or request, the mobile terminal apparatus 10 reads filenames which correspond to image data to be printed from the image storing portion 17, and shows a list of the filenames on the display portion 11 (step S6). The user chooses the file name of the image data to be printed. Here, the user can choose multiple files of the image data. The control portion 13 receives a printing start command from the operation portion in accordance with the user's operation (step S7). When the printing start command is received, the control portion 13 of the mobile terminal apparatus 10 assigns an ID number which is identifiable as a search key to each of image data corresponding to the selected filename (step S8). The control portion 13 of the mobile terminal apparatus 10 generates all ID list in XML (extensible markup language) format (step S9) in order to transmit information of the image data to be printed and a corresponding ID number.

As shown in FIG. 4, the mobile terminal apparatus 10 transmits the ID list for printing generated in XML format to the printing apparatus 30 (step S10). When the ID list for printing is received, the printing apparatus 30 reads the ID included in the ID list for printing in a manner such as reading one of the ID from the top one by one, and transmits it to the mobile terminal apparatus 10 as a transmission permission of the image data corresponding to the read ID (step S11). When the ID is received, the control portion 13 of the mobile terminal apparatus 10 refers to corresponding information and reads the image data corresponding to the received ID from the image storing portion 17, and transmits the image data to the printing apparatus 30 (step S12). The output portion 31 of the printing apparatus 30 receives the image and prints it (step S13). When the printing apparatus 30 finishes printing, the printing apparatus 30 checks whether or not there is still an ID which is not read yet in the ID list for printing. If there is an ID which has not been read yet, the operations of steps 10-14 are repeated in succession (step S14). If there are no IDs which have not been read yet, a printing end is transmitted to the mobile terminal apparatus 10 (step S15). In accordance with such a manner in which the image data is printed one by one, it is possible to design the printing apparatus 30 to conduct so as to request the next image data from the mobile terminal apparatus 10 every time printing of one file of the image data is finished, and it is possible to display the end of printing information on a screen of the mobile terminal apparatus 10 when printing is finished.

After printing is finished, with respect to the mobile terminal apparatus 10, it is possible for the user to pull out the cable and finish the overall printing operation, as well as print in succession if the user issues another print command again.

It should be noted that the operations of steps S6-S9 can be conducted only by the mobile terminal apparatus 10 before connecting the cable, and in such a case, the operations of steps S6-S9 are conducted before the operations of steps S1-S5.

Moreover, instead of showing the list of the read filenames, it is possible to print one file of the image data by selecting a print execution command from a submenu while the image data is shown on the display portion 11. In such a case, in the ID list for printing in XML format, only one ID is registered.

Furthermore, it is possible to show a list of thumbnails 110, and in such a case, the user chooses the thumbnail instead of the filename and printing is conducted.

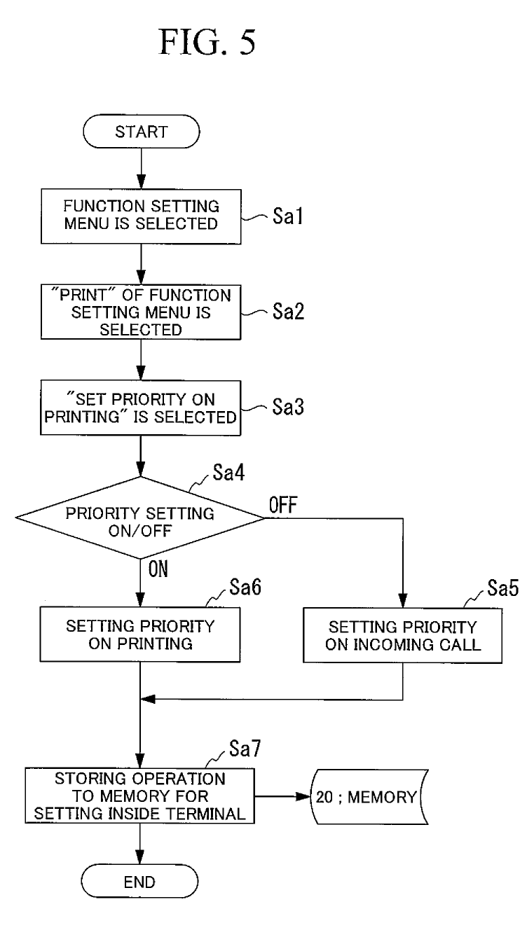

Referring to FIGS. 5 to 8, a priority setting operation is explained in which the mobile terminal apparatus 10 is set by the user beforehand whether a printing operation has a higher priority or an incoming call operation has a higher priority in a case of generation of an event of, for example, an incoming call while the printing operation is conducted.

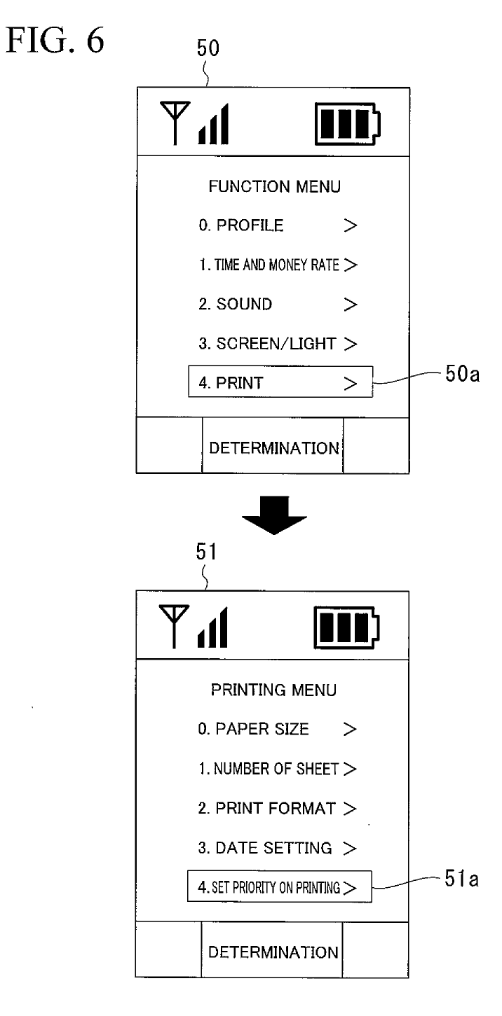

FIGS. 5 and 6 are respectively a flowchart and a screen transition diagram showing a case of setting a priority via a function setting menu.

In FIG. 5, first, the user operates the operation portion 12, and a screen (reference numeral 50) is displayed which is a function setting menu for displaying setting options on the display portion 11 (step Sa1). In accordance with the user's operation, a “print” option (reference numeral 50a) on the screen (reference numeral 50) is selected by the operation portion 12 (step Sa2). When the “print” option (reference numeral 50a) is selected, the screen of the display portion 11 changes to the screen (reference numeral 51) of FIG. 6. After that, in accordance with the user's operation, a “set priority on printing” option (reference numeral 51a) on the screen (reference numeral 51) is selected by the operation portion 12 (step Sa3). When the “set priority on printing” option (reference numeral 51a) is selected, a screen for selecting one of ON and OFF is shown on the display portion 11, and the user's selection of ON or OFF is detected (step Sa4). If the user selects “OFF” by operating the operation portion 12, the control portion 13 receives an input from the operation portion 12 so as to set the priority setting to “priority on incoming call” (step Sa5). On the other hand, if the user selects “ON” by operating the operation portion 12, the control portion 13 receives an input from the operation portion 12 so as to set the priority setting to “priority on printing” (step Sa6). After receiving the input of the priority setting information from the operation portion 12, the control portion 13 records the priority information setting to the memory 20 (step Sa7). Here, as an example, a case of setting a higher priority on printing with respect to the incoming call is explained; however, if the priority setting can be set with respect to each event such as an alarm, it is possible to further solve the needs and requirements of a user.

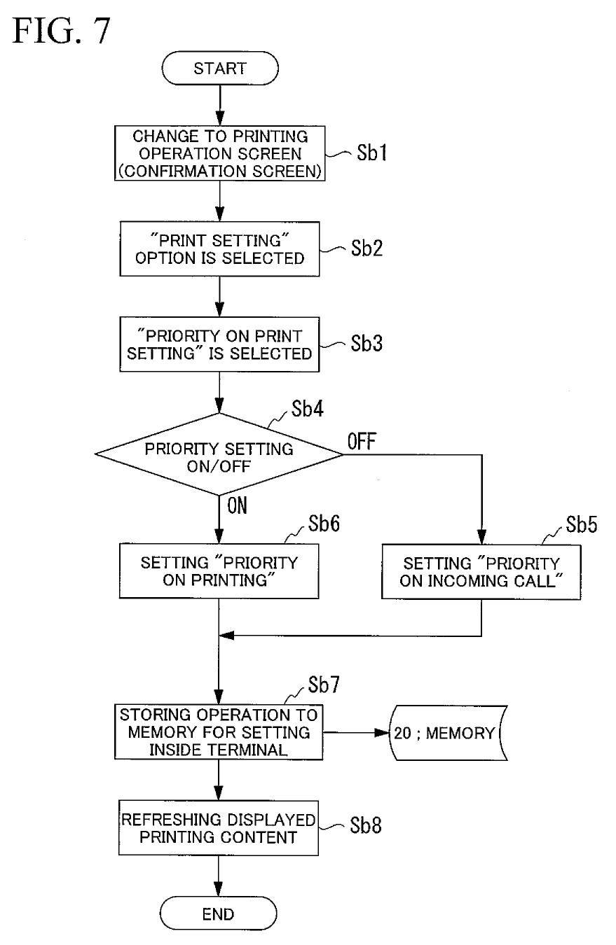

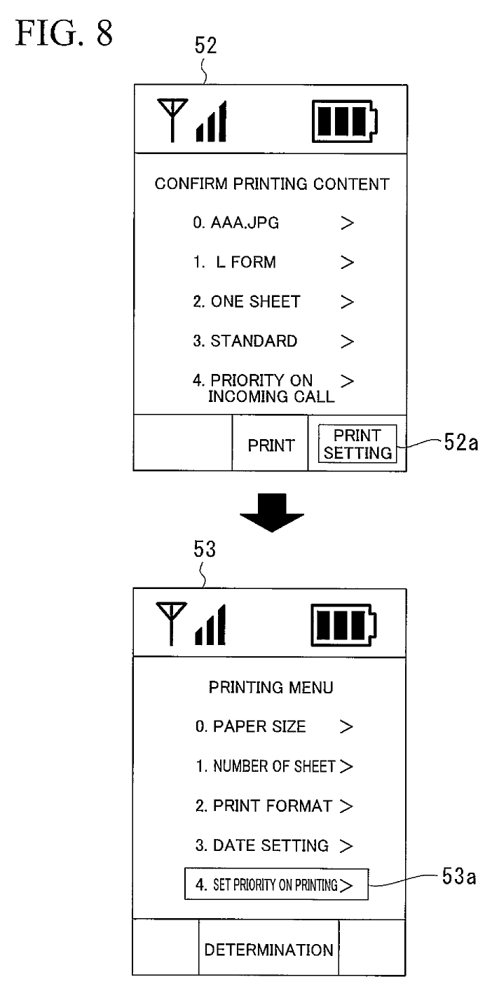

FIGS. 7 and 8 are respectively a flowchart and a screen transition diagram showing a case of setting a priority via a printing operation menu.

In FIG. 7, first, the user operates the operation portion 12, and the screen (reference numeral 52) of FIG. 8 is displayed which is a screen for confirming the content to be printed on the display portion 11 (step Sb1). A “print setting” option (reference numeral 52a) on the screen (reference numeral 52) is selected by the operation portion 12 which has accepted the user's operation (step Sb2). When the “print setting” option (reference numeral 52a) is selected, the screen of the display portion 11 switches to the screen (reference numeral 53) of FIG. 8. Next, a “priority on print setting” option (reference numeral 53a) on the screen (reference numeral 53) is selected by the operation portion 12 which has accepted user's operation (step Sb3). When the “priority on print setting” option is selected, a screen for selecting from ON and OFF is shown on the display portion 11, and the user decides which one of ON and OFF should be selected (step Sb4). When the user selects “OFF” by operating the operation portion 12, the control portion 13 receives an input from the operation portion 12 which means the priority setting is “priority on incoming call” (step Sb5). On the other hand, when the user selects “ON” by operating the operation portion 12, the control portion 13 receives an input from the operation portion 12 which means the priority setting is “priority on printing” (step Sb6). The control portion 13 which inputs the priority setting information from the operation portion 12 records the priority setting information in the memory 20 (step Sb7). A printing content screen (reference numeral 52) is updated and shown on the display portion 11 (step Sb8).

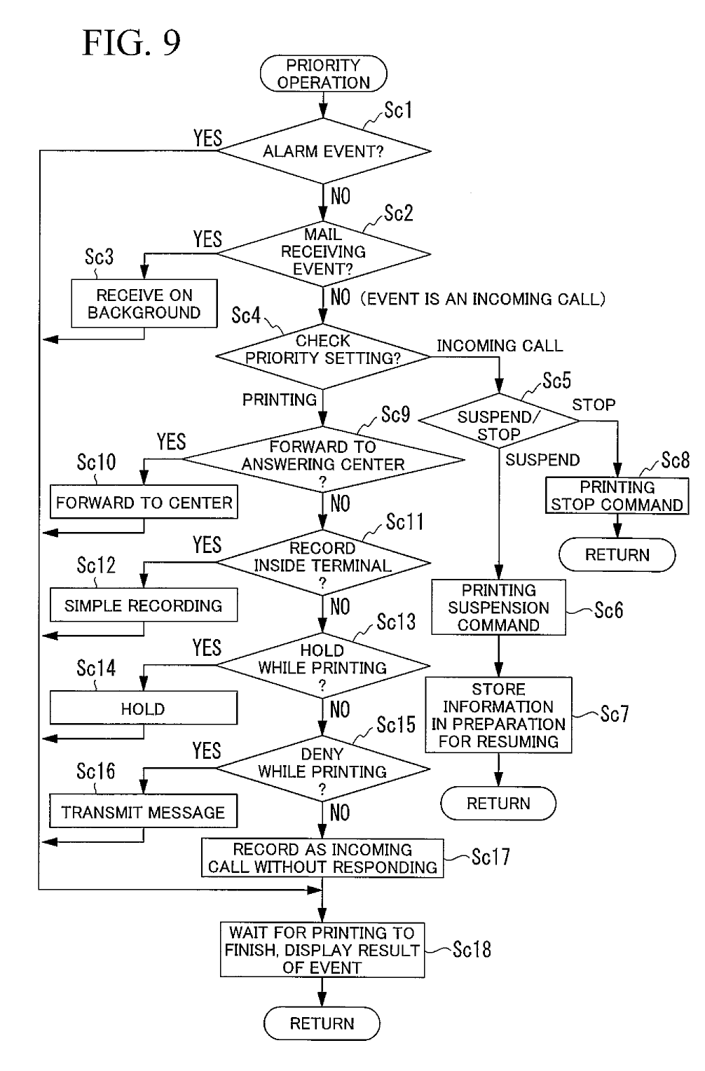

FIG. 9 is a flowchart showing a determination operation of a priority setting conducted by the control portion 13 when an event is detected by the control portion 13.

In FIG. 9, the event is, for example, an alarm event which is issued based on an alarm setting that is internally set to the mobile terminal apparatus 10, a mail receiving event which is caused when the email is received, an incoming call notifying event which is initiated when an incoming call is received, or the like, and there are an alarm sounding operation, a mail receiving operation, and an incoming call operation which corresponds to the events.

It should be noted that, with respect to the alarm event, an event is created inside the control portion 13, and with respect to both the mail receiving event and the incoming call event, an event is issued from the data operation portion 18 to the control portion 13.

First, when the image which is requested by the user to be printed is transmitted to the control portion 13 in accordance with the ID which is requested from the printing apparatus 30, if the control portion detects an event, it is checked whether or not it is an alarm event (step Sc1). When it is an alarm event, priority is set on a printing operation beforehand by the control portion 13 to the memory 20; therefore, the operation proceeds to step Sc18. When it is not an alarm event, it is checked whether or not it is a mail receiving event (step Sc2). When it is a mail receiving event, priority is set on a printing operation beforehand by the control portion 13 to the memory 20; therefore, without sounding an alarm or showing an display of receiving mail on the screen, the mail is received in the background and is stored in the memory 20 by the control portion 13; therefore the operation proceeds to step Sc18 (step Sc3).

Here, to the case in which the mail is received in the background is explained in detail. These days, with regard to the mail receiving event of the mobile terminal apparatus 10, multiple actions are needed. First, an acknowledgement from a base station with respect to the reception of a mail which is directed to an address of the mobile terminal apparatus 10 and which is received by a mail server on the network, is received by the communication portion 14. After that, when the communication portion 14 receives the acknowledgement, the control portion controls and requests the communication portion 14 to connect to the mail server in order to receive the mail. In many cases, actions of at least such two steps are needed. Therefore, if the priority setting is “priority on printing” while the image data is transmitted by the connection portion 13, and if the communication portion 14 receives the acknowledgement of the mail, the control portion 13 does not immediately request to receive the mail, and transmission of a file of image data which is currently transmitted is finished first. When the transmission of the image data is finished, the printing apparatus 30 continuously requests transmission of the next image data to be printed; however, the control portion 13 requests the communication portion 14 to connect to the mail server at this time and requests to start receiving the acknowledged mail based on information included in the acknowledgement. While this operation is conducted, a display showing the state of the transmitting print data is maintained. When reception of the mail is finished, the control portion 13 transmits the image data corresponding to the ID which is requested by the printing apparatus 30 via the connection portion 13.

Therefore, the mobile terminal apparatus 10 can receive the mail in the background without stopping the printing operation, and there is no case which needs user's operation. Especially, with respect to image data which is requested to be printed, the quality of image is important; therefore, it has a large size. Therefore, if multiple files are selected, it takes a long time to transmit. It can be assumed that there are many cases in which the user steps away from the mobile terminal apparatus 10 when the printing operation is started, and the user comes back after a while. In such a case, if the printing operation is unexpectedly stopped during operation because of an event of low priority such as the reception of an email, or the like, it is necessary for the user to operate the apparatus again in order to resume the printing operation; however, the above-described constitution can prevent such the case.

Moreover, with respect to a notification of a reception of a mail, it is preferable to conduct after finishing a series of printing operations. In other words, it is preferable to display the reception of the mail or to generate a sound in order to notify the user of a newly received email after the completion of transmitting all image data corresponding to multiple images which are requested to print to the printing apparatus 30.

In the case of an event other than the mail receiving event, the detected event is determined to be the incoming call event, and the priority setting is determined. If the priority setting is “OFF”, that is, if the priority is set on an incoming call (step Sc4; incoming call), information with respect to the printing being suspended or stopped is set beforehand is referenced. If it is set to suspend printing (step Sc5; suspension), it is different from a case of receiving an email, and the user should be notified of an incoming call as soon as possible because there is a possibility in which the incoming call will not be answered. Therefore, the control portion 13 transmits a printing suspension command to the printing apparatus 30 via the connection portion 16 in order to suspend printing (step Sc6). When the printing apparatus 30 receives this, a signal which indicates an agreement to change to a posing state in which the printing operation is suspended is transmitted to the connection portion 16. Moreover, when the control portion 13 transmits the printing suspension command, the control portion 13 stores information which relates to the progress of the printing operation conducted at that time to the memory 20 in preparation for resuming (step Sc7). It should be noted that the information which is necessary for resuming is the ID list, the IDs of the ID list which are finished printing, and the ID which is in a process of transmitting the image data to the printing apparatus 30.

After storing the information which is necessary for resuming, the mobile terminal apparatus 10 starts a notification operation corresponding to this incoming call such as generating a ring alert and changes to a talk state after an off-hook operation by the user. During this operation, if there is image data which has already transmitted from the mobile terminal apparatus 10 and started printing, the printing apparatus 30 prints the image data to the last; therefore, the user can save time effectively. Moreover, if the image data is incompletely received from the mobile terminal apparatus 10, it is possible to discard the image data. However, it is possible to control the progress, for example, by storing a packet number of the respective image which has been transmitted. In this case, the image data is maintained until printing is resumed, the printing apparatus 30 notifies the mobile terminal apparatus 10 that there is image data which is incompletely received upon resuming, and the mobile terminal apparatus 10 is requested to transmit only the remaining image data.

After that, when all the operations of incoming calls and talking are finished, the control portion 10 sends a request to resume to the printing apparatus 30 via the connection 16, and resumes transmission of the image data which was not finished printing yet.

At this time, if the conversation is finished in an unexpectedly short time and the printing apparatus 30 is still printing, the printing apparatus 30 does not give transmission permission of the image data when the mobile terminal apparatus 10 notifies a user of the resumption of printing. The printing apparatus 30 requests the mobile terminal apparatus 10 to wait until the end of printing, and the printing apparatus 30 transmits the next ID of the image data as transmission permission to the mobile terminal apparatus 10 when the printing apparatus 30 finishes printing. After that, the mobile terminal apparatus 10 resumes transmission of the image data.

In accordance with such a manner in which the printing apparatus 30 and the mobile terminal apparatus 10 refer to and confirm the ID list with each other, it is possible to avoid printing the same image data twice.

On the other hand, if it is set to stop printing (step Sc5; stop), the control portion 13 transmits a printing stop command to the printing apparatus 30 via the connection portion 16 (step Sc8).

If the priority setting is “ON”, that is, if the priority is set on printing (step Sc4; printing), setting information of operations for incoming call which is set beforehand is referenced. If the setting information is set to forward to an answering center which corresponds to the above-described predetermined forwarding address (step Sc9), the control portion 13 transmits a forwarding command to the data operation portion 18, and the incoming call is forwarded to the answering center (step Sc10). Next, if the setting information is set to record inside the terminal (step Sc11), the control portion 13 requests the data operation portion 18 to establish a telephone communication of the incoming call, receives voice signals from the data operation portion 18, and records the voice signals to the memory 20 (step Sc12).

Next, if the setting information is set to hold while printing (step Sc13), the control portion 13 outputs a request to the data operation portion 18 to establish a telephone communication of the incoming call. The control portion 13 reads hold melody data, or the like which is stored in the memory 20 beforehand, and transmits the hold melody data to the established call via the data operation portion 18 (step Sc14). Next, if the setting information is set to deny while printing (step Sc15), the control portion 13 outputs a request to the data operation portion 18 to establish a telephone communication of the incoming call. The control portion 13 reads a response message such as “Currently incoming calls are not accepted” which corresponds to the above described predetermined message, and the like which are stored in the memory 20 beforehand, and transmits the response message to the established call via the data operation portion 18 (step Sc16). If the setting information does not correspond to the above-described settings, the control portion 13 stores a record in the memory 20 indicating an incoming call to which nothing is responded (step Sc17). On the other hand, in the case of an alarm event or an email receiving event, if the priority setting indicates that the priority is on printing, the control portion 13 waits for printing to finish, and displays the result of the event on the display portion 11 (step Sc18). In other words, the result or the response to an event such as: an incoming call was forwarded to the answering center because printing had a higher priority even though the call was detected; a message has been recorded inside the terminal; a caller has been put on hold; the incoming call was denied; or there was no response, is displayed or notified to the user by a sound. Especially with respect to placing a caller on hold, the telephone connection of the incoming call is established and the connection is maintained; therefore, a holding tone is output from a speaker 19a after holding is selected, the user can hear the holding tone even when the printing operation is conducted; therefore, it is possible to notify the user that the call has been held.

With respect to information for resuming in step Sc7, there is other information such as: information of a printing job which is conducted by the control portion 13; setting information of printing size; or the performance information received from the above-described printing apparatus. Because such information is stored in the memory 20 upon suspending printing, it is possible to resume printing after finishing the conversation.

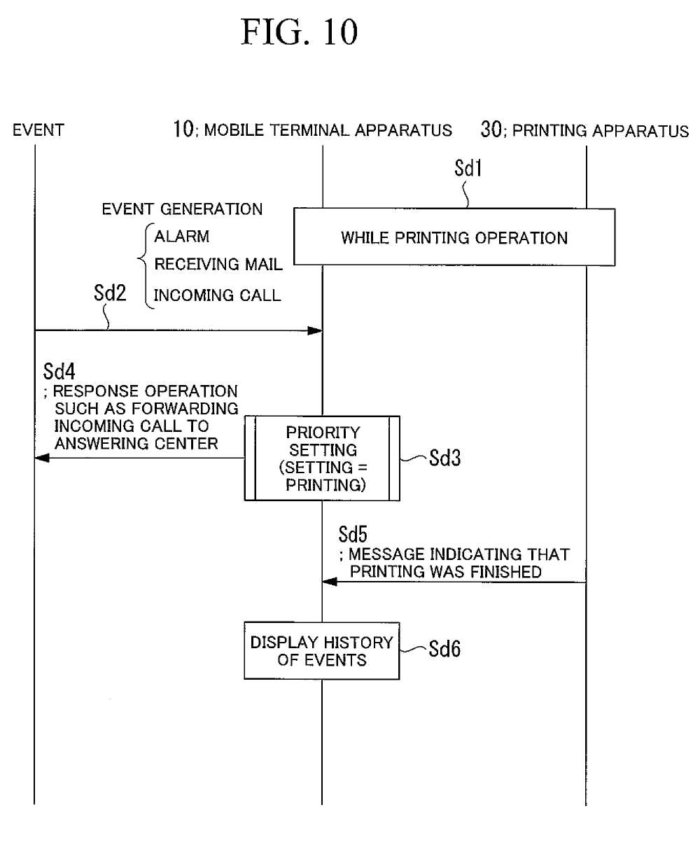

FIG. 10 is a sequence diagram showing a priority operation of the mobile terminal apparatus 10 in which the printing operation is set to be a higher priority, in the case of generating an event while conducting a printing operation.

First, it is assumed that the above-described priority setting operation has been conducted on the mobile terminal apparatus 10, and that the priority setting is “ON”, that is, the setting indicates that printing has a higher priority. Between the mobile terminal apparatus 10 and the printing apparatus 30, printing operations of steps S11-S14 of FIG. 4 have been conducted (step Sd1). While printing, an event is created, generated, accepted or received, and the control portion 13 of the mobile terminal apparatus 10 is notified of the event (step Sd2). The control portion 13 which detects the event conducts the above-described priority operations (step Sd3). In the priority operation, if the detected event is, for example, an incoming call event of a telephone call, a response operation such as forwarding the incoming call to an answering center, is conducted (step Sd4). If printing has a higher priority, the mobile terminal apparatus 10 waits for printing to finish. When the printing apparatus 30 finishes the printing operation, a message indicating that printing was finished is transmitted to the mobile terminal apparatus 10 (step Sd5). When the mobile terminal apparatus 10 receives a message indicating that printing was finished, the mobile terminal apparatus 10 shows a history of the events on the display portion 11. For example, in the case of an incoming call, a call register is shown (step Sd6).

Other than the above-described case in which printing is not finished until the printing apparatus 30 finishes printing with respect to all IDs, as described in FIG. 9, if the printing apparatus 30 transmits a new ID after the mobile terminal apparatus 10 has transmitted the image data of the ID which was requested from the printing apparatus 30, it is possible to prevent transmitting the image data of the new ID. Moreover, in the case in which the: image data is constituted in pages, with respect to image data which is being transmitted when the mobile terminal apparatus 10 detects an event, it is possible to finish transmitting the image data corresponding to the currently printing page and to stop transmitting the image data that follows. In such a case, the printing apparatus 30 detects that it is not possible to receive the image data for a certain time period, and transmits a message indicating that printing was finished. By stopping the transmission of the image data per ID or per page, there is no possibility in which printing is stopped at the printing apparatus 30 even though it is in the middle of printing one sheet of paper, and moreover, it is possible to waste paper, ink and toner.

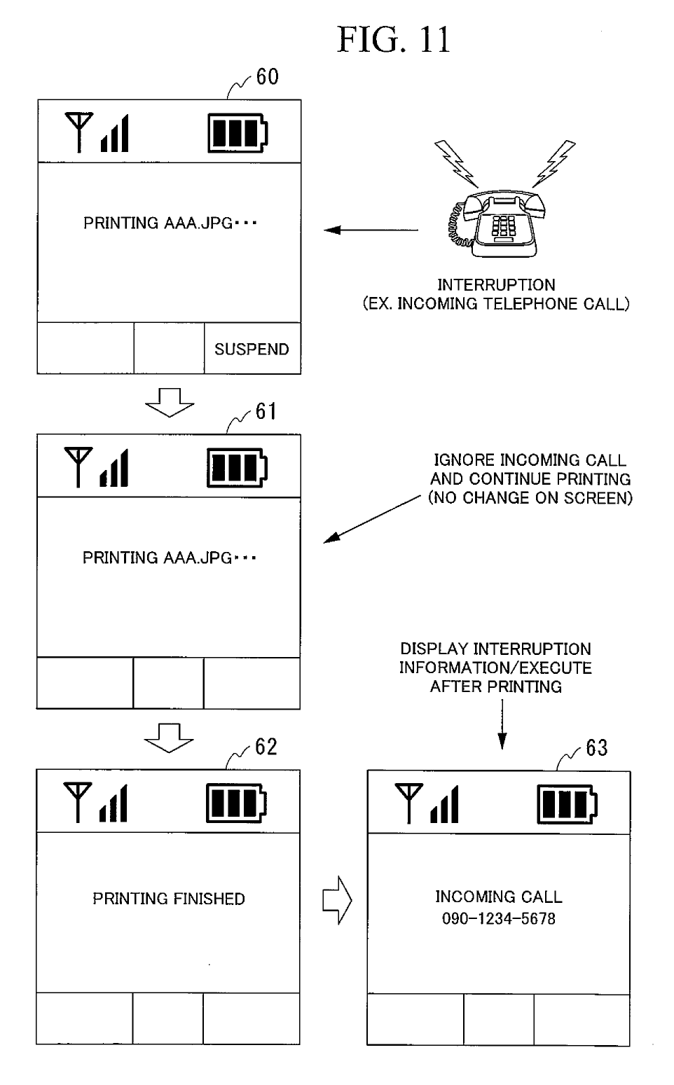

FIG. 11 shows a screen transition diagram shown on the display portion 11 in steps in which a printing operation has higher priority in FIG. 10.

First, a message which shows that image data of AAA.JPG is being printed on a screen (reference numeral 60). At that time, an incoming call event is generated or created. The priority setting indicates that the priority is on printing; therefore, the message which shows that the image data which is AAA.JPG is being printed is continuously shown on the screen (reference numeral 61). And when it has finished printing and a message indicating that printing was finished is received from the printing apparatus 30, a message indicating that printing was finished is shown on the screen (reference numeral 62). After that, a message which shows that there was an incoming call is shown on the screen (reference numeral 63).

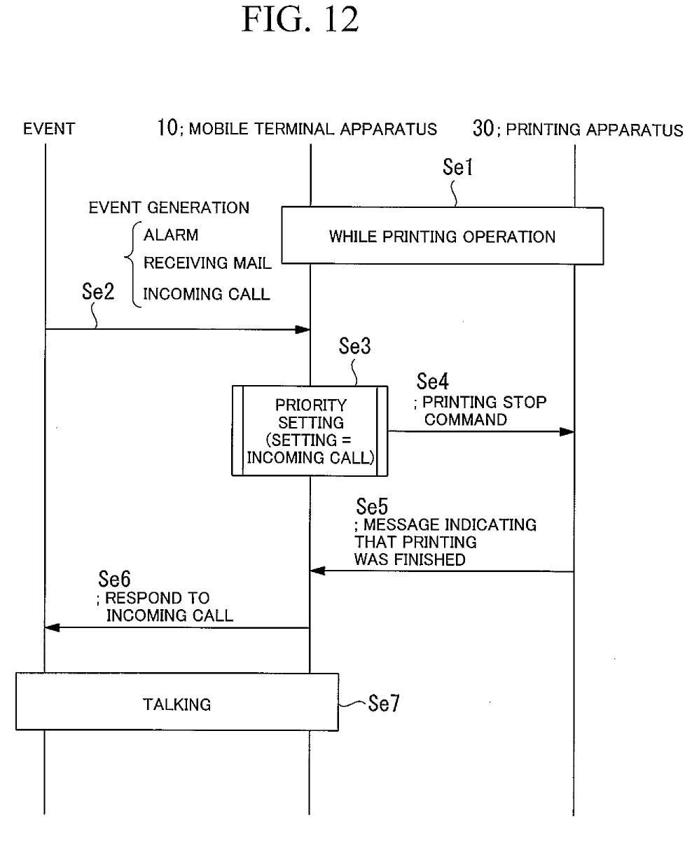

FIG. 12 is a sequence diagram which shows the priority operation of the mobile terminal apparatus 10 in a case in which the mobile terminal apparatus 10 is set to give a priority on an incoming call when an event is generated or created while conducting a printing operation, and in which the printing operation is stopped.

First, the above-described priority setting operation is already applied to the mobile terminal apparatus 10, and the priority setting is “OFF”, in other words, the setting indicates that the incoming call operation has priority. The printing operations of steps S11-S14 shown in FIG. 4 are conducted between the mobile terminal apparatus 10 and the printing apparatus 30 (step Se1). An event is generated or created while printing, and the event is notified to the control portion 13 of the mobile terminal apparatus 10 (step Se2). When the control portion 13 detects the event, the control portion 13 conducts the above-described priority operations (step Se3). In this priority operation, if the detected event is, for example, an incoming call event of a telephone call, a printing stop command is transmitted to the printing apparatus 30 (step Se4) in accordance with the setting information set beforehand. When the printing apparatus 30 receives the printing stop command, the printing apparatus 30 stops printing and transmits a message indicating that printing was finished to the mobile terminal apparatus 10 (step Se5). After that, when a user operation is received, the control portion 13 outputs a request to the data operation portion 18 to establish a telephone connection (step Se6). A talk state is started (step Se7). Depending on thw shielding ability of the connection portion 16, there is a possibility in which a small amount of noise is involved while the communication portion 14 is communicating; however, a response to the incoming call is conducted after completely printing in such the manner; therefore, it is effective to prevent a problem of the noise.

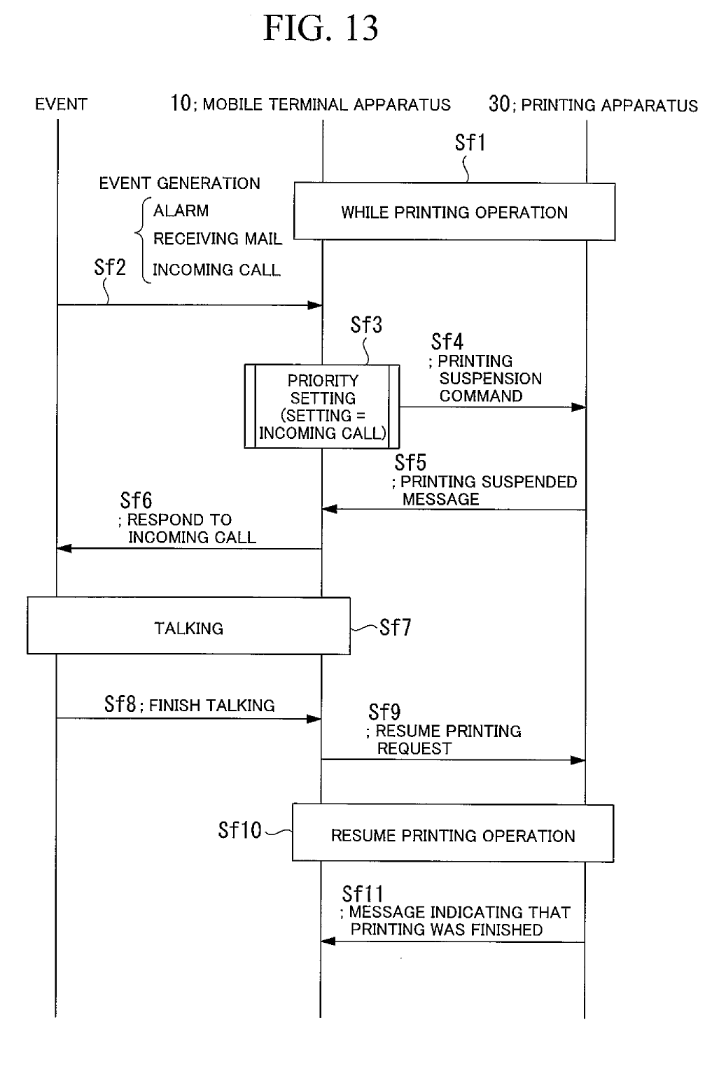

FIG. 13 is a sequence figure showing a priority operation of the mobile terminal apparatus 10, in which a telephone call has priority when an event is generated or created while conducting a printing operation, and which resumes the printing operation after suspending it.

First, the above-described priority setting operation is already applied to the mobile terminal apparatus 10, and the priority setting is “OFF”, that is, the setting indicates that the incoming call operation has priority. Printing operations of steps S11-S14 shown in FIG. 4 are conducted between the mobile terminal apparatus 10 and the printing apparatus 30 (step Sf1). An event is generated or created while printing, and the event is notified to the control portion 13 of the mobile terminal apparatus 10 (step Sf2). When the control portion 13 detects the event, the control portion 13 conducts the above-described priority operations (step Sf3). In this priority operation, if the detected event is, for example, an incoming call event of a telephone call, a printing stop command is transmitted to the printing apparatus 30 in accordance with the setting information which is set beforehand. At that time, the control portion 13 of the mobile terminal apparatus 10 stores information for resuming to the memory 20 (step Sf4). When the printing apparatus 30 receives the printing suspension command, the printing apparatus 30 suspends printing and transmits a printing suspend message to the mobile terminal apparatus 10 (step Sf5). After that, when a user operation is received, the control portion 13 outputs a request to the data operation portion 18 to establish a telephone connection (step Sf6). Then, a talk state is started (step Sf7). After that, when the conversation is finished (step Sf6), the control portion 13 of the mobile terminal apparatus 10 transmits a resume printing request to the printing apparatus 30 via the connection portion 16 (step Sf9). The printing apparatus 30 transmits a transmission request of the image data corresponding to the ID which is suspended to the mobile terminal apparatus 10, and resumes the printing operation (step Sf10). After finishing printing, the printing apparatus 30 transmits a message indicating that printing was finished to the mobile terminal apparatus 10.

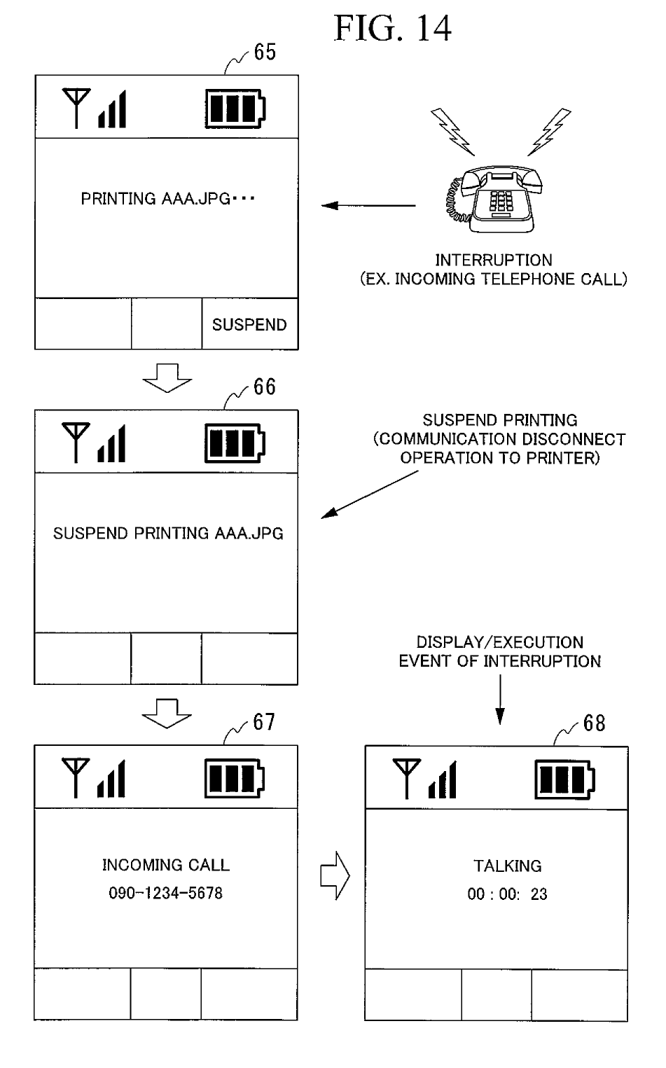

FIG. 14 is a drawing which shows a screen transition shown on the display portion 11 while conducting steps of an operation in which an incoming call has higher priority, printing is stopped or printing is suspended.

First, a message which shows that image data AAA.JPG is being printed on a screen (reference numeral 65). At that time, an incoming call event is generated or created. The priority setting indicates that the priority is on the incoming call; therefore, the message which shows that printing is stopped is continuously shown on the screen (reference numeral 66). Printing is stopped, and a message of incoming call is shown on the screen (reference numeral 67). After that, a telephone communication of the incoming call is established in accordance with the user's operation, a talk state is started, and a message which indicates the talk state is shown on the screen (reference numeral 68).

On the other hand, when printing is suspended, a message which indicates suspension of printing is shown on the screen ((reference numeral 66), and after showing a message which indicates talk state on the screen (reference numeral 68), the screen returns to a message which indicates printing (reference numeral 65) along with resumin printing.

As described above, information as to whether printing has priority or an operation corresponding to an event has priority is set beforehand based on a user's command; therefore, it is possible for the mobile terminal apparatus 10 to select and conduct one of the printing operation and the operation corresponding to the event. Therefore, when the event which is generated or created is an incoming call event, if the printing operation has priority, even in a state of continuing the printing operation, it is possible to conduct an operation of forwarding the incoming call to the answering center, an operation of responding to the incoming call and recording inside the apparatus, an operation of putting the caller on hold, and an operation of responding to the incoming call and transmitting a response message.

With respect to an event such as an alarm event or a mail reception event in which the printing operation always has higher priority, by setting the printing operation to have higher priority beforehand, it is possible to conduct the alarm event and the mail reception event in the background, and to conduct the printing operation with priority at anytime.

On the other hand, when the mail reception event is generated or created, at a timing of finishing transmitting the image data which is currently being transmitted, the communication portion 14 is requested to start receiving the mail. After receiving the mail, the image data corresponding to the ID requested from the printing apparatus 30 is transmitted to the printing apparatus 30 via the connection portion 13; therefore, it is possible to receive mail in the background without stopping the printing operation, and there is no case which needs user's operation.

On the other hand, if a priority is set on the incoming call, when an incoming call event is generated or created, it is possible to stop or suspend the printing operation, and to respond to the incoming call. Moreover, when the printing operation is suspended, printing information just before, for example, the ID list, the IDs which have been printed in the ID list, the ID which was transmitted halfway to the printing apparatus 30, and the like are information necessary for resuming and are stored; therefore, it is possible to resume the printing operation after reading the necessary information for resuming.

The above described mobile terminal apparatus includes a computer system. The above-described priority setting or steps of the priority setting operation are stored in the form of a program in a computer readable medium, and the above-described operations are conducted by the computer which reads and executes this program. Here, the computer readable medium is a magnetic disc, magneto-optical disc, a CD-ROM, a DVD-ROM, a semiconductor disc, or the like. Moreover, it is possible to distribute the computer program to the computer and to execute the program by the using the computer which received the program.

### INDUSTRIAL APPLICABILITY

In accordance with the present invention, it is possible to obtain a mobile terminal apparatus, a printing system, a printing communication control method and a computer program of the same which can select and conduct one of a printing operation and an operation corresponding to an event even if an unexpected event is occurred such as the reception of a telephone call, the arrival of an email, or the like.

1. A mobile terminal apparatus comprising:
a memory unit which stores image data;
a printing communication unit which communicates with a connected apparatus for printing the image data, reads the image data stored in the memory unit and transmits the image data; and
a control unit which selects whether an event operation which corresponds to the event or a printing operation has priority when generation of the event is detected while conducting the printing operation by the printing communication unit.

2. A mobile terminal apparatus according to claim 1, wherein
the memory unit storing priority information indicates whether the event operation or the printing operation has priority, and
the control unit conducts a priority operation based on the priority information stored in the memory unit.

3. A mobile terminal apparatus according to claim 1, wherein if a generation of an event is detected in a case in which the printing operation is set to be an operation with priority, the control unit notifies the generation of the event after the printing communication unit finishes transmitting the image data.

4. A mobile terminal apparatus according to claim 1, wherein if a generation of an event is detected in a case in which the event operation is set to be an operation with priority, transmission of the image data by the printing communication unit is suspended.

5. A mobile terminal apparatus according to claim 2, wherein:
the generated event has a plurality of types; and
the memory unit stores the priority information in correspondence with the types of the event.

6. A mobile terminal apparatus according to claim 1, wherein
the mobile terminal apparatus comprises a wireless communication unit which can connect to a public communication network,
the event is an incoming call via the wireless communication unit, and
if a generation of the incoming call is detected in a case in which the printing operation is set to be an operation with priority while the printing operation is conducted, at least one of following controls is conducted:
(a) forwarding the incoming call to a predetermined forwarding address;
(b) responding to the incoming call along with recording received voice;
(c) holding the incoming call; and
(d) responding to the incoming call along with transmitting a predetermined message.

7. A mobile terminal apparatus according to claim 2, wherein if the control unit accepts a specification of whether the event operation or the printing operation is conducted as an operation with priority via the operation unit, priority information with respect to the operation with priority is stored by the control unit to the memory unit.

8. A printing system, wherein
the printing system comprises:
a mobile terminal apparatus according to claim 1; and
an image forming apparatus which prints image data received from the mobile terminal apparatus, and
the image forming apparatus comprises:
a second control unit which communicates with the communication unit with respect to printing;
an image receiving unit which receives the image data from the mobile terminal apparatus; and
an image outputting unit which outputs the image data received by the image receiving unit as an image.

9. A printing communication method of a mobile terminal apparatus which connects to an image forming apparatus that prints image data, and transmits image data that is stored beforehand to the image forming apparatus, the printing communication method comprising:
conducting an operability/usability check and recognition with the mobile terminal apparatus when a connection to the image forming apparatus is detected;
selecting image data to be printed;
conducting a printing operation of the selected image data;
attempting to detect generation of an event while conducting the printing operation; and
selecting whether an event operation corresponding to the event or the printing operation is conducted as an operation with priority when the event is detected.

10. A mobile terminal apparatus comprising:
a storage unit which stores image data;
a printing communication unit which communicates with a connected apparatus for printing the image data, reads the image data from the memory unit and transmits the image data; and
a control unit which, if generation of the event is detected while conducting the printing operation by the printing communication unit, conducts an event operation corresponding to the event when transmission of at least one set of image data is finished.

11. A mobile terminal apparatus according to claim 10, wherein if the control unit detects the generation of the event while transmitting the image data via the printing communication unit and conducts the event operation corresponding the event when transmission of at least one set of the image data which is transmitted is finished, the control unit suspends the printing operation.

12. A mobile terminal apparatus according to claim 11, wherein if the event operation which is conducted after suspension of the printing operation is finished and there is other image data following the one set of image data, the control unit requests the printing communication unit to transmit the other image data.

13. A mobile terminal apparatus according to claim 11, wherein when the control unit suspends the printing operation of the printing communication unit, the control unit stores progress information of the printing operation to the memory unit in order to resume the printing operation.

14. A mobile terminal apparatus according to claim 10, wherein the event is a mail reception event, and the event operation is a connection operation to a mail server in order to receive an electronic mail.

15. A printing system comprising:
a mobile terminal apparatus according to claim 10; and
an image forming apparatus which prints the image data received from the mobile terminal apparatus, wherein the image forming apparatus comprises:
a second control unit which communicates with the printing communication unit for the printing operation;
an image receiving unit which receives image data from the mobile terminal apparatus; and
an image output unit which outputs the image data as an image which is received by the image receiving unit.

16. A printing communication method of a mobile terminal apparatus which connects to an image forming apparatus that prints image data, and transmits image data that is stored beforehand to the image forming apparatus, comprising the steps of:
a step of selecting image data to be printed;
a step of conducting a printing operation of the selected image data;
a step of attempting to detect a generation of an event while conducting the printing operation;
a step of detecting end of transmission of one set of the image data which is transmitted while conducting the printing operation; and
a step of conducting an event operation corresponding to the event when the end of transmission of the one set of the image data is detected.

17. A mobile terminal apparatus comprising:
a memory unit which stores image data;
a printing communication unit which communicates with a connected apparatus for printing the image data, reads the image data from the memory unit and transmits the image data from; and
a control unit which, if generation of the event is detected while conducting a printing operation by the printing communication unit, suspends transmitting the image data and conducts an event operation corresponding to the event.

18. A mobile terminal apparatus according to claim 17, wherein
the printing communication unit assigns identification information which is identifiable to the image data respectively which is a target of the printing operation, and transmits the identification information to an image forming apparatus, and
the control unit stores relationship of correspondence between the identification information and the image data to the memory unit upon suspending transmission of the image data, and transmits the image data to the image forming apparatus based on the relationship of correspondence after finishing the event operation.

19. A mobile terminal apparatus according to claim 18, wherein the control unit requests the printing communication unit to transmit the image data corresponding to the requested identification information from the image forming apparatus to the image forming apparatus based on the relationship of correspondence after finishing the event operation.

20. A mobile terminal apparatus according to claim 17, wherein the control unit stores progress information of transmission of the image data as resume information to the memory unit in order to resume the image data when the control unit suspends transmission of the image data via the printing communication unit, and resumes based on the resume information.

21. A mobile terminal apparatus according to claim 17, wherein when a transmission of the image data is suspended because a generation of an event is detected while the printing communication unit is conducting a printing operation, the control unit does not suspend transmission of the image data until one set of the image data is completed, and suspends transmission of other image data following the one set of the image data.

22. A mobile terminal apparatus according to claim 21, wherein the control unit requests the printing communication unit to transmit the other image data following the one set of the image data when the event operation is finished.

23. A printing system comprising:
a mobile terminal apparatus according to claim 17; and
an image forming apparatus which prints the image data received from the mobile terminal apparatus, wherein the image forming apparatus comprises:
a second control unit which communicates with the printing communication unit with respect to the printing operation,
an image receiving unit which receives image data from the mobile terminal apparatus, and
an image output unit which outputs the image data as an image which is received by the image receiving unit.

24. A printing communication method of a mobile terminal apparatus which connects to an image forming apparatus that prints image data, and transmits image data that is stored beforehand to the image forming apparatus, the printing communication method comprising:
selecting image data to be printed;
conducting a printing operation of the selected image data;
attempting to detect a generation of an event while conducting the printing operation;
suspending transmission of the image data which is transmitted in the printing operation when a generation of the event is detected; and
conducting an event operation corresponding to the event after suspending transmission of the image data.
